(19) United States
(12) Patent Application Publication
(10) Pub. No.: US 2025/0267337 A1
(43) Pub. Date: Aug. 21, 2025

(54) METHOD AND SERVER FOR PROVIDING RECOMMENDED CHANNEL LIST BY USING CLUSTERING

(71) Applicant: SAMSUNG ELECTRONICS CO., LTD., Suwon-si (KR)

(72) Inventor: Injune BAEK, Suwon-si (KR)

(73) Assignee: SAMSUNG ELECTRONICS CO., LTD., Suwon-si (KR)

(21) Appl. No.: 19/196,190

(22) Filed: May 1, 2025

Related U.S. Application Data
(63) Continuation of application No. PCT/KR2023/018425, filed on Nov. 16, 2023.

(30) Foreign Application Priority Data
Dec. 14, 2022 (KR) 10-2022-0174953

(51) Int. Cl. H04N 21/482

(52) U.S. Cl. CPC H04N 21/4826

(57) ABSTRACT

A server obtains use history information including time information of a plurality of display devices, obtains, based on the use history information, use characteristics by the time information and overall use characteristics for each of the plurality of users corresponding to a plurality of display devices, groups the use characteristics by the time information for a plurality of users into M groups by clustering, and the overall use characteristics for a plurality of users into N groups by clustering, obtains a recommended channel list including at least one of a first preferred channel corresponding to a first group including use characteristics by the time information of a first user among the M groups or a second preferred channel corresponding to a second group including overall use characteristics of the first user among the N groups, and provides the recommended channel list to a display device corresponding to the first user.

### CROSS-REFERENCE TO RELATED APPLICATIONS

This application is a continuation of International Application No. PCT/KR2023/018425, filed Nov. 16, 2023, and claims priority to Korean Application No. 10-2022-0174953, filed Dec. 14, 2022, which are incorporated herein by reference in their entireties.

### TECHNICAL FIELD

The disclosed embodiments relate to a method of providing a recommended channel list by using clustering and an electronic device according thereto.

### BACKGROUND ART

According to the technological developments of display devices and communication systems, various types of content have been provided through various types of display devices. Display devices are connected to wired or wireless communication networks to provide a variety of types of content to users.

Recently, as the types of content have diversified, display devices may provide different types of content. A display device receives at least one content from a plurality of communication networks connected in a wired/wireless manner and provides the at least one content to a user. As content diversifies, users have difficulty selecting desired content from a large amount of content, and thus, a method of recommending content to each user is necessary. Accordingly, there is a need to provide a list of recommended channels selected from among a variety of types of content considering the characteristics of each user.

### DISCLOSURE OF INVENTION

### Solution to Problem

In an embodiment of the present disclosure, a method of providing a user-personalized recommended channel list by a server may include a step of obtaining use history information including time information of a plurality of display devices. The method may include a step of obtaining, based on the use history information, use characteristics by the time information and overall use characteristics for each of the plurality of users corresponding to a plurality of display devices. The method may include a step of grouping the use characteristics by the time information for a plurality of users into M groups by clustering the same, and the overall use characteristics for a plurality of users into N groups by clustering the same. The method may include a step of obtaining a recommended channel list including at least one of a first preferred channel corresponding to a first group including use characteristics by the time information of a first user of a plurality of users among the M groups by the time information or a second preferred channel corresponding to a second group including overall use characteristics of the first user among the N groups for the overall use characteristics. The method may include a step of providing a recommended channel list to a first display device corresponding to the first user among a plurality of display devices.

In an embodiment of the present disclosure, a server for providing a user-personalized recommended channel list may include a transceiver, a memory storing one or more instructions, and at least one processor that executes the one or more instructions. The at least one processor may be configured to obtain use history information including time information of a plurality of display devices, and use characteristics by time information and overall use characteristics for each of a plurality of users corresponding to a plurality of display devices based on the use history information. A server according to an embodiment may group the use characteristics by the time information for a plurality of users into M groups by time information by clustering the use characteristics by the time information for the plurality of users, and group the overall use characteristics for a plurality of users into N groups by clustering the overall use characteristics for the plurality of users. A server according to an embodiment may obtain a recommended channel list including at least one of a first preferred channel corresponding to a first group including use characteristics by the time information of a first user of a plurality of users among the M groups by the time information or a second preferred channel corresponding to a second group including overall use characteristics of the first user among the N groups for the overall use characteristics. A server according to an embodiment may provide a recommended channel list to a first display device corresponding to a first user among a plurality of display devices.

### BRIEF DESCRIPTION OF DRAWINGS

FIG. 1 is a diagram for explaining a system for providing a user-personalized recommended channel list, according to an embodiment of the present disclosure.

FIG. 2 is a diagram for explaining a method of providing a user-personalized recommended channel list, according to an embodiment of the present disclosure.

FIG. 3 is a schematic block diagram of a server according to an embodiment of the present disclosure.

FIG. 4 is a flowchart for explaining a method of providing a user-personalized recommended channel list, according to an embodiment of the present disclosure.

FIG. 5 is a flowchart for explaining a method of providing a user-personalized recommended channel list based on the presence or absence of use history information, according to an embodiment of the present disclosure.

FIG. 6 is a flowchart for explaining a method of providing a user-personalized recommended channel list by using a data base, according to an embodiment of the present disclosure.

FIG. 7 is a diagram for explaining an example of clustering a plurality of users, according to an embodiment of the present disclosure.

FIG. 8 is a diagram for explaining a clustering result for each of a plurality of users, according to an embodiment of the present disclosure.

FIG. 9 is a diagram for explaining a method of providing a recommended channel list, according to an embodiment of the present disclosure.

FIG. 10 is a diagram for explaining a method of clustering a plurality of users, according to an embodiment of the present disclosure.

FIG. 11A is a diagram for explaining an example of providing a user-personalized recommended channel list for each genre, according to an embodiment of the present disclosure.

FIG. 11B is a diagram for explaining an example of providing a user-personalized recommended channel list for each genre, according to an embodiment of the present disclosure.

FIG. 12 is a diagram for explaining an example of providing a user-personalized recommended channel list, according to an embodiment of the present disclosure.

### MODE FOR THE INVENTION

Hereinafter, embodiments of the present disclosure are described in detail with reference to the accompanying drawings.

As the present disclosure allows for various changes and numerous embodiments, embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed in the present disclosure.

In the description of the present disclosure, certain detailed explanations of the related art are omitted when it is deemed that they may unnecessarily obscure the essence of the present disclosure. Furthermore, numbers, such as “first,” “second,” etc., used to describe various components are used only to distinguish one element from another.

The terms used in the present disclosure have been selected from currently widely used general terms in consideration of the functions in the present disclosure. However, the terms may vary according to the intention of one of ordinary skill in the art, case precedents, and the advent of new technologies. Furthermore, for special cases, meanings of the terms selected by the applicant are described in detail in the description section. Accordingly, the terms used in the present disclosure are defined based on their meanings in relation to the content discussed throughout the specification, not by their simple meanings.

The scope of the present disclosure is defined not by the detailed description of the present disclosure but by the appended claims. Also, various features referred to in one claim category (e.g., a method claim) of the present disclosure may be identically applied to the claims of other categories (e.g., a system claim) in an appropriate method. Furthermore, an embodiment of the present disclosure may include not only combinations of features set forth in the appended claims, but also various combinations of individual features within the claims. The scope of the present disclosure is defined not by the detailed description of the present disclosure but by the appended claims, and all changes and modifications introduced from the concept and scope of the claims and the equivalent concept thereof will be construed as being included in the present disclosure.

In the present disclosure, components expressed as ‘unit’, ‘module’, etc., may be combined into a single component from two or more components, or a single component may be divided into two or more components based on more detailed functions. The function may be embodied by hardware or software or by a combination of hardware and software. Furthermore, each of the constituent elements to be described below may additionally perform some or all of the functions of other constituent elements in addition to a main function thereof, and some of the main functions of each constituent element may be exclusively performed by other constituent elements.

The expression of singularity in the present disclosure includes the expression of plurality unless clearly specified otherwise in context. Terms used herein including technical or scientific terms have the same meanings as those generally understood by those of ordinary skill in the art to which the present disclosure may pertain.

In the entire disclosure, unless specified otherwise, “or” is not inclusive and exclusive. Accordingly, unless expressly indicated otherwise or otherwise indicated in context, expressions such as “A or B”, “A, or B”, and similar expressions, may include any of the following: A, B, A and B. Similarly, expressions such as “A and B”, “A, and B”, and similar expressions, may include any of the following: A, B, A and B. In the present disclosure, the term “at least one of” or “one or more . . . ” may mean a case in which different combinations of one or more items among the listed items may be used, or any one item only is needed from the listed items. For example, expressions such as “at least one of A, B and C”, “at least one of A, B, and C”, “at least one of A, B or C”, “at least one of A, B, or C”, and similar expressions, may include any one of the following combinations: A, B, C, A and B, A and C, B and C, A and B and C.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block(s). These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block(s) The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block(s).

Furthermore, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The embodiment of the present disclosure is described with reference to the accompanying drawings so that one skilled in the art to which the disclosure pertains can easily work the disclosure. However, the disclosure is not limited thereto and it will be understood that various changes in form and details may be made therein without departing from the spirit and scope of the following claims. In the drawings, a part that is not related to a description is omitted to clearly describe the disclosure and, throughout the specification, similar parts are referenced with similar reference numerals.

Terms used in the present disclosure are briefly described, and an embodiment of the present disclosure is described in detail.

The terms described below are defined in consideration of their functions in the present disclosure, and may vary depending on the intention or custom of the user or operator. Therefore, the definitions should be made based on the content throughout this specification.

In the present disclosure, ‘use history information’ may refer to records of viewing channels, content, or the like, or records of using applications, TV, or the like.

In the present disclosure, ‘use characteristics’ may refer to statistic values obtained by using information about the viewed channels or content or the used applications or TV.

In the present disclosure, ‘clustering’ may refer to grouping together data with similar characteristics for unlabeled data.

In the present disclosure, ‘clustering’ may refer to grouping multiple pieces of data with similar characteristics into groups as a result of clustering, and may have a different meaning from ‘classification’, which divides data with labels.

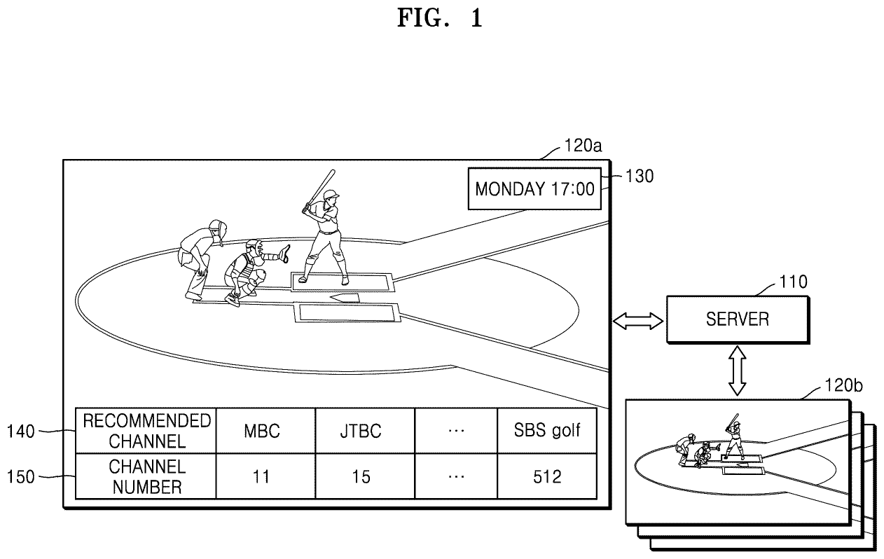

FIG. 1 is a diagram for explaining a system for providing a user-personalized recommended channel list, according to an embodiment of the present disclosure.

Referring to FIG. 1, a system for providing a user-personalized recommended channel list according to an embodiment may include a server 110 and a plurality of display devices 120a and 120b. FIG. 1 illustrates a method of providing a recommended channel list 140 during a specific time slot by the server 110 through a display device 120, according to an embodiment.

A method of recommending channels based on channels, content, or genre of content viewed by a user for each time slot has a problem in that various channels may not be recommended when the user has no or insufficient history of viewing the channel or content in the corresponding time slot. Hereinafter, in the present disclosure, a method of recommending channels when no or insufficient viewing history exists is described.

In an embodiment of the present disclosure, a system for providing the recommended channel list 140 may include the plurality of display devices 120a and 120b. The plurality of display devices 120a and 120b may be implemented in various forms. For example, the plurality of display devices 120a and 120b of the present disclosure may each include digital cameras, laptop computers, tablet PCs, electronic book terminals, terminals for digital broadcasting, personal digital assistants (PDAs), portable multimedia players (PMPs), smart phones, or the like, but the present disclosure is not limited thereto.

In an embodiment of the present disclosure, the plurality of display devices 120a and 120b may transmit use history information including time information to the server 110. The time information may include information about time slots, days, or dates on which a plurality of users viewed or used display devices. The use history information may include viewing channel history information by time information, viewing content history information by time information, application use history information by time information, or TV use history information by time information, but the present disclosure is not limited thereto.

In an embodiment of the present disclosure, the server 110 may create the recommended channel list 140 based on the received use history information through various analysis methods. For example, the server 110 may analyze and cluster use history information of a plurality of display devices and create a recommended channel list for each time slot.

In an embodiment of the present disclosure, the server 110 may obtain use characteristics by time information and overall use characteristics for each user from the use history information of each user.

The server 110, by using the obtained information, may provide a recommended channel list to a user in a different manner according to whether the use history of the user using the display device 120a exists in a specific time slot.

In the present disclosure, the server 110 may generate a recommended channel list with diversity and serendipity even when no use history of the user using the display device 120 exists in a specific time slot. In detail, the server 110 may create groups by clustering overall use characteristics and identify preferred channels of each group. in case that no use history of a user exists in a specific time slot, the server 110 may generate a recommended channel list including preferred channels of a group to which the user belongs, among the clustered groups of the overall use characteristics. Accordingly, even in case that no use history of a user exists in a specific time slot, various recommended channel lists may be provided.

Furthermore, the server 110 may create groups by clustering use characteristics by time information and identify preferred channels of each group. When the use history of a user using the display device 120 exists in a specific time slot, the server 110 may generate recommended channel list including preferred channels of a group to which the user belongs, among groups obtained by clustering use characteristics by time information corresponding to a specific time slot. Accordingly, even for users with little viewing history, as the server 110 may use preferred channels of the clustered groups, a recommended channel list with diversity may be provided.

The server 110 according to an embodiment of the present disclosure may obtain use characteristics by time information of each of the plurality of users from the use history for the plurality of users obtained from the plurality of display devices 120a and 120b, and group the user characteristics by time information into at least one group by clustering the use characteristics by time information. Furthermore, the server 110 may identify preferred channels for at least one group by time information. Furthermore, the server 110 may obtain overall use characteristics for each user from use history, and group the user characteristics by time information into at least one group by clustering the overall use characteristics. The server 110 may identify preferred channels for each group.

For example, it may be assumed that a user (hereinafter, referred to as the “first user”) of the first display device 120a uses the first display device 120a in the Monday 17:00 130.

When use history of the first user includes use history corresponding to the Monday 17:00 130, the server 110 may obtain the recommended channel list 140 including preferred channels of a group to which use characteristics by time information of the first user belongs, among one or more groups created for the time information including the Monday 17:00 130. The server 110 may provide the obtained recommended channel list 140 to the first display device 120a. The first display device 120a may display the recommended channel list 140 on a screen.

When the use history of the first user does not include the use history corresponding to the Monday 17:00 130, the server 110 may obtain the recommended channel list 140 including preferred channels of a group to which overall use characteristics of the first user belong, among one or more groups grouped by clustering overall use characteristics. The server 110 may provide the obtained recommended channel list 140 to the first display device 120a. The first display device 120a may display the recommended channel list 140 on the screen.

In an embodiment of the present disclosure, when a channel number 150 corresponding to the recommended channel list 140 exists, the server 110 may provide the recommended channel list 140 and together the channel number 150.

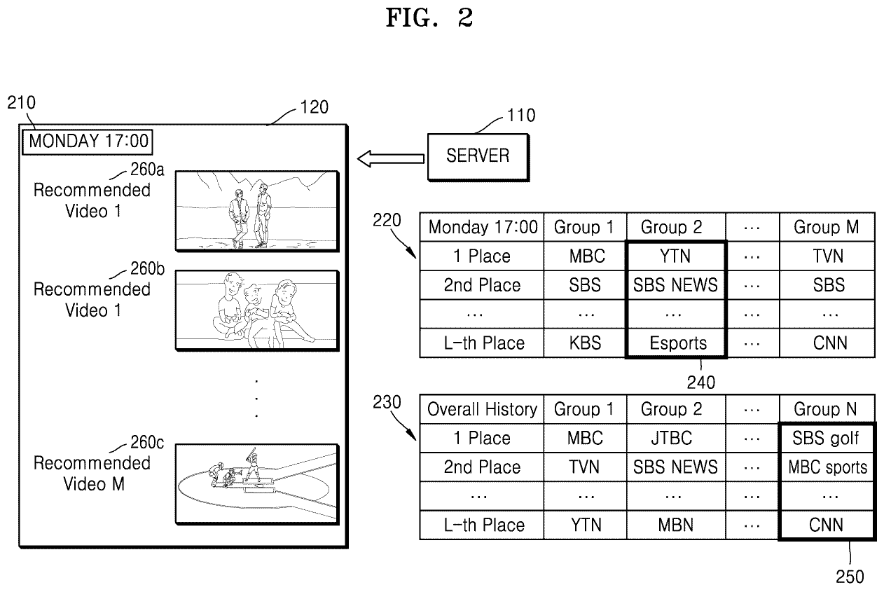

FIG. 2 is a view for explaining a method of providing a user-personalized recommended channel list, according to an embodiment of the present disclosure. Hereinafter, for a brief description of the specification, descriptions redundant to those in FIG. 1 are omitted.

Referring to FIG. 2, a system for providing a user-personalized recommended channel list may include the server 110 and the display device 120. The server 110 may cluster a plurality of users of a plurality of display devices by using use history information obtained from the plurality of display devices, and group the clustered plurality of users into one or more groups.

The server 110 may obtain use characteristics by time information and overall use characteristics for each user by using time information included in the use history information of each user. The server 110 may cluster the obtained use characteristics by time information and group the clustered use characteristics into M groups. The server 110 may identify preferred channels for each of M groups and store a preferred channel ranking 220 for each group.

The server 110 may obtain overall use characteristics from the use history information of each user. The server 110 may group the overall use characteristics into N groups by clustering the obtained overall use characteristics. The server 110 may identify preferred channels for each of the N groups and store the preferred channel ranking 230 for each group.

The server 110 may create a recommended channel list depending on whether use history of a user exists in a specific time slot for each user based on the preferred channel ranking 220 and 230 for each group and transmit the created recommended channel list to the display device 120.

For example, when the server 110 provides a user with a recommended channel list corresponding to a Monday 17:00 210, the server 110 may create different recommended channel lists depending on whether use history of a user includes use history corresponding to the Monday 17:00 210.

When the use history of a user includes use history corresponding to the Monday 17:00 210, the server 110 may use the preferred channel ranking 220 of M groups obtained by grouping time information including the Monday 17:00 210. The server 110 may obtain recommended videos (recommended channel lists) 260a, 260b, and 260c including preferred channels 240 of Group 2 including the use characteristics by time information of a user, among M groups corresponding to the Monday 17:00 210. The server 110 may provide the obtained recommended channel lists 260a, 260b, and 260c to a user by transmitting the same to the display device 120.

When the use history of a user does not include use history corresponding to the Monday 17:00 210, the server 110 may use the preferred channel ranking 230 about the preferred channels of the N groups grouped by clustering the overall use characteristics. The server 110 may obtain the recommended channel lists 260a, 260b, and 260c including preferred channels 250 of group N including the overall use characteristics of a user, among the N groups obtained by clustering the overall use characteristics. The server 110 may provide the obtained recommended channel lists 260a, 260b, and 260c to a user by transmitting the same to the display device 120.

The detailed configuration and operation of a recommended channel list providing method and a display device according to an embodiment of the present disclosure are described below in detail with reference to the accompanying drawings.

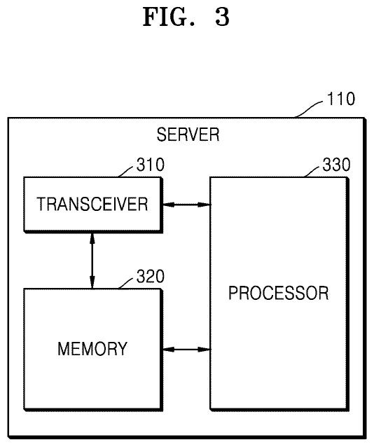

FIG. 3 is a schematic block diagram of a server according to an embodiment of the present disclosure.

Referring to FIG. 3, the server 110 according to an embodiment of the present disclosure may include a transceiver 310 that transceives with an external device (not shown), a memory 320 that stores one or more instructions, and a processor 330 that performs at least one instruction. However, the illustrated components are not all essential components. The server 110 may be implemented by more components than the illustrated components, and the server 110 may be implemented by less components than the illustrated components.

The transceiver 310 may transceive with external devices (not shown) through a wired/wireless network. Here, the external device (not shown) is a device capable of transceiving content using a channel and may include a broadcast station server, a content storing device, a display device, etc.

The transceiver 310 according to an embodiment may include at least one communication module, such as a short-range communication module, a wired communication module, a mobile communication module, a broadcast receiving module, etc. Here, the at least one communication module may refer to a communication module capable of performing data transceiving through a network that complies with communication standards, such as a tuner performing broadcast reception, Bluetooth, Wireless LAN (WLAN) (Wi-Fi), Wireless broadband (Wibro), World Interoperability for Microwave Access (Wimax), CDMA, WCDMA, etc. The transceiver 310 according to an embodiment may receive use history information of each of a plurality of users from a plurality of display devices and transmit the obtained recommended channel lists to a display device. Furthermore, the transceiver 310 may update use history information by receiving use history information from the plurality of display devices at preset intervals.

The memory 320 may store program commands or code executed on the processor 330, and store pieces of input/output data (e.g., a pose of an object, a reference score for each pose, score assigned to the pose, a still image, etc.). In an embodiment, the memory 320 may be implemented by a plurality of memories.

The memory 320 may include at least one type of storage media including memory (e.g., an SD or XD memory etc.) of a flash memory type, a hard disk type, a multimedia card micro type, and a card type, Random Access Memory (RAM) Static Random Access Memory (SRAM), Read-Only Memory (ROM), Electrically Erasable Programmable Read-Only Memory (EEPROM), Programmable Read-Only Memory (PROM), a magnetic memory, a magnetic disk, and an optical disc.

In an embodiment of the present disclosure, the memory 320 may store use history information, use characteristics by time information, overall use characteristics, use characteristics clustering information, preferred channels for each group, or a recommended channel list, which are received for a predetermined period. The use history information may include time information about a plurality of display devices. The clustering information may refer to information about grouping of a plurality of users based on use characteristics obtained from the use history information.

The processor 330 may typically control the overall operation of the server 110. For example, the processor 330 may obtain, by executing the instructions or the like stored in the memory 320, use characteristics by time information of each of users and overall use characteristics by using the received use history information. The processor 330 may group a plurality of users into one or more groups by clustering the plurality of users based on the use characteristics. Furthermore, the processor 330 may identify preferred channels of one or more groups, and obtain a recommended channel list to be provided to a user. In an embodiment, the processor 330 may be implemented by a plurality of processors.

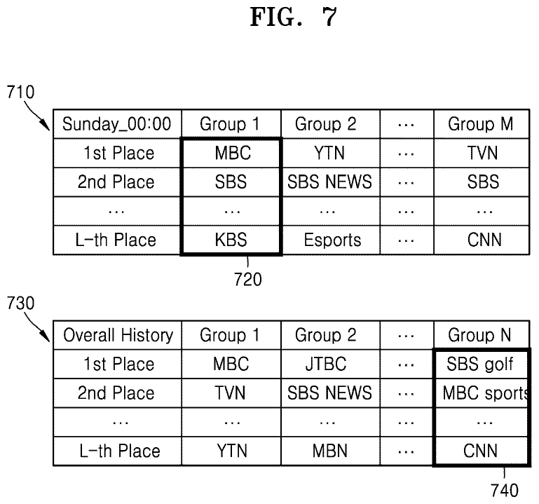

In an embodiment of the present disclosure, the processor 330 may obtain the use characteristics by time information and the overall use characteristics for a plurality of users based on the use history information received from the plurality of display devices. The processor 330 may group a plurality of users into one or more groups by clustering the plurality of users based on the obtained use characteristics by time information and overall use characteristics. The processor 330 may identify preferred channels for each group and provide a recommended channel list depending on the presence or absence of the use history of a user in a specific time slot. A method of obtaining a recommended channel list is described below in detail with reference to FIGS. 7 to 9.

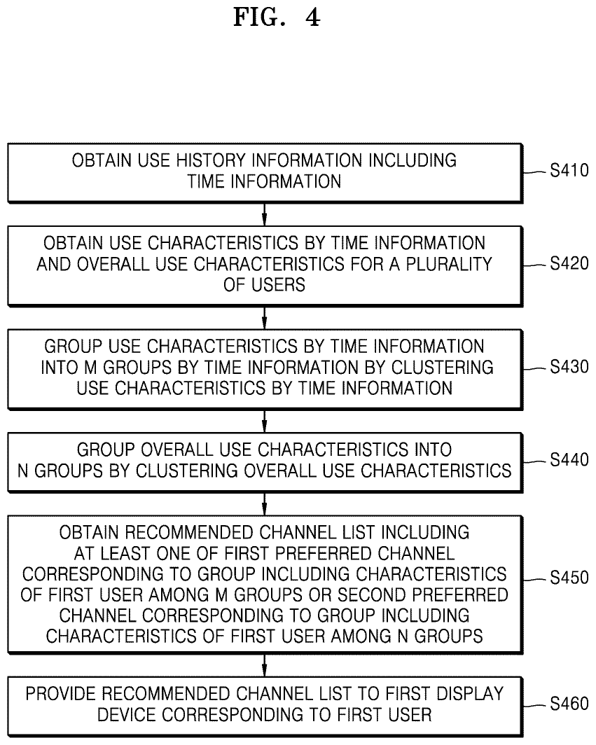

FIG. 4 is a flowchart for explaining a method of providing a user-personalized recommended channel list, according to an embodiment of the present disclosure.

In operation S410, the server 110 may obtain use history information including time information.

In an embodiment of the present disclosure, the server 110 may receive use history information of each display device from a plurality of display devices. The use history information may include time information. The time information included in the use history information may include time, day, or date when a user used a display device. Furthermore, the use history information may include viewing channel history information by time information, viewing content history information by time information, application use history information by time information, or TV use history information by time information, but the present disclosure is not limited thereto.

For example, when a user watched news on Monday 8:00, the use history information may include information, such as Monday, 8:00, and news. Alternatively, when a user watched a documentary using an application A on Saturday at 10:00, the use history information may include information, such as Saturday, 10:00, application A, and documentary.

In operation S420, the server 110 may obtain the use characteristics by time information and the overall use characteristics for a plurality of users. The server 110 may obtain use characteristics by time information and overall use characteristics based on the use history information obtained in operation S410.

In an embodiment of the present disclosure, the server 110 may obtain use characteristics by time information for a plurality of users by using the time information included in the use history. The time information may include time slot, day, and date information when a plurality of users used or viewed a display device. The server 110 may obtain use characteristics by time information of a plurality of users based on the time slot, day, and date information.

In an embodiment of the present disclosure, the server 110 may obtain overall use characteristics for a plurality of users regardless of the time information. The server 110 may obtain overall use characteristics not including time information based on information including viewing channels, viewing content or applications, and history about TV use of a plurality of users. For example, use characteristics regarding preferred channel, genre, etc. of a user may be obtained based on information about channels that the user viewed for a week.

In an embodiment of the present disclosure, the server 110 may use, as use characteristics, a statistical value obtained by calculating a channel statistical usage rate of integrated history or for each time slot. The server 110 may use, as use characteristics, a statistical value obtained by calculating a genre statistical usage rate of integrated history or for each time slot. The server 110 may use, as use characteristics, a statistical value obtained by calculating a statistical rate value of words included in viewing content. Furthermore, the server 110 may use, as use characteristics, a statistical usage rate calculated by using integrated history or history for each time slot of an application or TV.

The statistical value according to an embodiment may include a Term Frequency-Inverse Document Frequency (TF-IDF) value. The TF-IDF value may mean a weight that indicates how important a particular word is among several documents. In detail, TF is a value that indicates the frequency with which a specific word appears in a document, and DF indicates the frequency with which a specific word itself appears in a document group that includes the document, and IDF indicates the reciprocal of the value. The TF-IDF value means a product of a TF value and an IDF value. Accordingly, the higher the TF value and the lower the DF value, the higher the weight of the word.

For example, as a word “strength” in exercise content may have both a high TF value and a high DF value, the TF-IDF value itself may not be high. Conversely, if a word “book” appears frequently within a specific exercise content, the TF value will be high, and considering that the word “book” does not appear frequently within general exercise content, the IDF value will also be high. Accordingly, the TF-IDF value may be calculated to be high. In an embodiment of the present disclosure, the use characteristics may include a TF-IDF value of word or genre, but the present disclosure is not limited thereto.

In an embodiment of the present disclosure, the server 110 may obtain and store the use characteristics by time information and the overall use characteristics for a plurality of users.

In operation S430, the server 110 may group the use characteristics by time information into M groups by information by clustering the use characteristics by time information. The server 110 may cluster a plurality of users by using the use characteristics by time information obtained in operation S420.

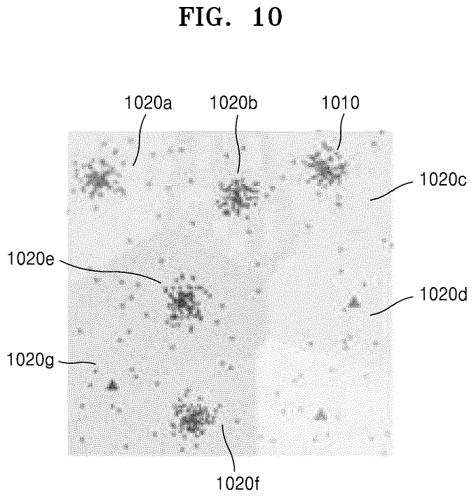

In an embodiment of the present disclosure, the server 110 may group a plurality of users into M groups by time information by clustering the use characteristics by time information for a plurality of users. The server 110 may set or adjust the number of groups for grouping a plurality of users. The server 110 may cluster the use characteristics by time information based on the set number of groups. The server 110 may classify a plurality of users by using all or some of the obtained use characteristics by time information. The time information may include a time slot, day, or date, and the server 110 may group a plurality of users for each time slot, day or date. For example, when a plurality of users are grouped into M groups for each of 7 days and 24 hours, a total of 7×24×M groups may be created. Hereinafter, a clustering method is described in detail with reference to FIG. 10.

For example, the server 110 may cluster a plurality of users on Friday, 3 pm, and group the clustered plurality of users into M groups. The server 110 may group the plurality of users into M groups by clustering the use characteristics by time information including Friday, 3 pm.

In an embodiment of the present disclosure, the server 110 may identify preferred channels for each of the clustered M groups. The server 110 may set the number of preferred channels to be identified and identify preferred channels for each group based on the set number of preferred channels. The server 110 may identify preferred channels for each group based on the use characteristics and obtain a ranking of preferred channels.

In an embodiment of the present disclosure, the server 110 may store information about at least one group that is grouped through clustering. Furthermore, the server 110 may store preferred channels for each group together. Hereinafter, an operation of identifying preferred channels after clustering is described in detail with reference to FIG. 7.

In operation S440, the server 110 may group overall use characteristics into N groups by clustering the overall use characteristics. The server 110 may cluster a plurality of users by using the overall use characteristics obtained in operation S420.

In an embodiment of the present disclosure, the server 110 may group a plurality of users into N groups by clustering the overall use characteristics. The server 110 may set or adjust the number of groups for grouping a plurality of users. The number of groups groped by clustering the overall use characteristics and the number of groups grouped by clustering the use characteristics by time information may be set or adjusted to be identical. Alternatively, the number of groups groped by clustering the overall use characteristics and the number of groups grouped by clustering the use characteristics by time information may be set or adjusted to be different from each other. The server 110 may cluster the overall use characteristics based on the set number of groups. The server 110 may group a plurality of users by using all or some of the obtained overall use characteristics.

In an embodiment of the present disclosure, the server 110 may identify preferred channels for each of the clustered N groups. The server 110 may set the number of preferred channels and identify preferred channels for each group based on the set number of preferred channels. The server 110 may identify preferred channels based on the use characteristics and obtain a ranking of preferred channels.

In an embodiment of the present disclosure, the server 110 may store information about the groups that are grouped through clustering. Furthermore, the server 110 may store the preferred channels for each group together.

In operation S450, the server 110 may obtain a recommended channel list including at least one of a first preferred channel corresponding to a group including the characteristics of a first user among M groups or a second preferred channel corresponding to a group including the characteristics of the first user among N groups.

In an embodiment of the present disclosure, the server 110 may obtain a recommended channel list by using the preferred channels for each group that are grouped through clustering. The server 110 may identify a group to which the use characteristics of the first user belong among M groups or N groups to provide a recommended channel list to the first user. The server 110 may provide a recommended channel list including the preferred channels of the group to which the use characteristics of the first user belong.

In an embodiment of the present disclosure, the preferred channels for each group may include channels related to channels, genres, or contents viewed by the groups. For example, when a plurality of users are grouped, through clustering, into groups based on genre, preferred channels may include channels related to genre for each group.

In an embodiment of the present disclosure, the server 110 may obtain a recommended channel list from different groups depending on whether the use history of the first user exists in a specific time slot. In detail, when the use history of the first user exists in a specific time slot, the server 110 may identify a first group including the use characteristics by time information of the first user among M groups for the time information including the specific time slot. The server 110 may identify a first preferred channel corresponding to the identified first group and obtain a recommended channel list including the first preferred channel. Furthermore, the recommended channel list may include, together with the first preferred channel, at least one channel that the first user has mainly viewed in the specific time slot.

Furthermore, when no use history of the first user exists in the specific time slot, the server 110 may identify a second group including the overall use history of the first user, among the N groups grouped depending on the overall use characteristics. The server 110 may identify a second preferred channel corresponding to the identified second group and obtain a recommended channel list including the second preferred channel.

For example, when no use history of the first user exists at 7 am on Monday, the server 110 may identify M groups obtained by clustering time information including 7 am on Monday, among results of clustering the use characteristics by time information. The server 110 may identify a first group including the use characteristics of the first user among the M groups corresponding to 7 am on Monday and obtain a recommended channel list including a first preferred channel corresponding to the first group. The recommended channel list may include at least one channel that the first user viewed at 7 am on Monday.

Furthermore, when no use history of the first user at 7 am on Tuesday exists, the server 110 may identify a second group including the use characteristics of the first user, among N groups obtained from a result of clustering the overall use characteristics. The server 110 may obtain a recommended channel list including a second preferred channel corresponding to the second group.

In operation S460, the server 110 may provide a recommended channel list to a first display device corresponding to the first user.

In an embodiment of the present disclosure, the server 110 may obtain a recommended channel list corresponding to the operation S450. When the use history of the first user exists in a specific time slot, the server 110 may provide to the first user a recommended channel list including a preferred channel obtained by using the use characteristics by time information. Furthermore, the recommended channel list may include at least one channel that the first user mainly has viewed in a specific time slot.

When no use history of the first user exists in a specific time slot, the server 110 may provide a recommended channel list including a preferred channel obtained by using the overall use characteristics.

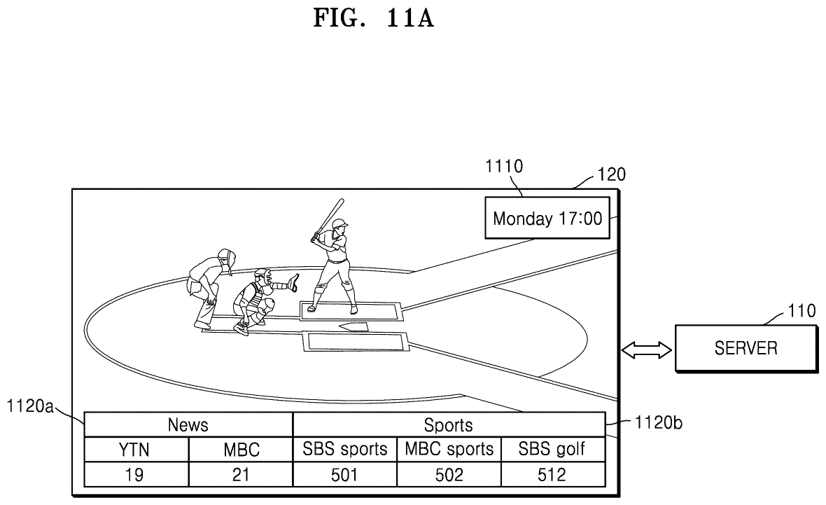

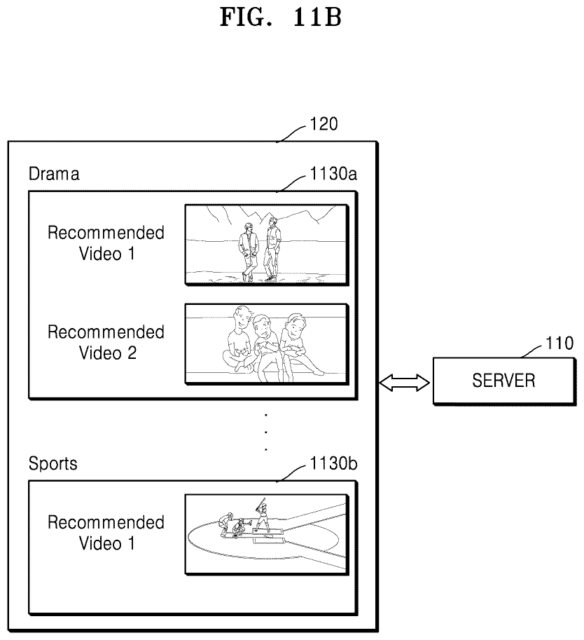

In an embodiment of the present disclosure, the server 110 may provide a recommended channel list in various forms to the first display device corresponding to the first user. For example, channel numbers corresponding to the recommended channels may be provided together with a recommended channel list, or genre to which the recommended channels belong may be provided together with a recommended channel list. Hereinafter, a specific example is described with reference to FIGS. 11A and 11B.

In an embodiment of the present disclosure, the server 110 may obtain use history information of a plurality of display devices at preset intervals and update the use history information. The server 110 may perform clustering again on a plurality of users by using the updated use history information, and recreate and provide a recommended channel list to a user.

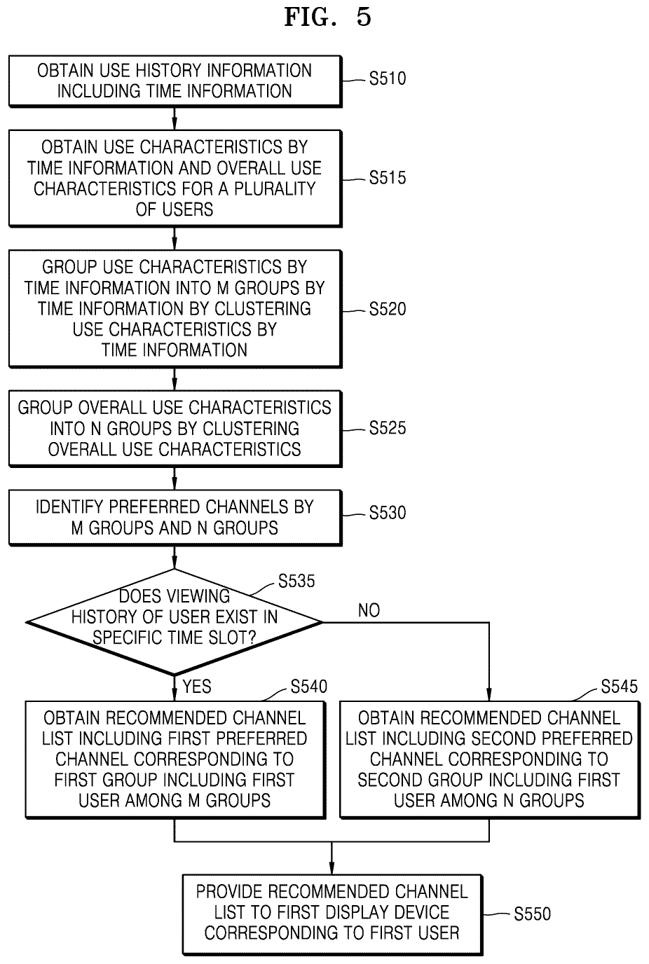

FIG. 5 is a flowchart for explaining a method of providing a user-personalized recommended channel list based on the presence or absence of use history information, according to an embodiment of the present disclosure. Hereinafter, for a brief description of the specification, descriptions redundant to those in FIG. 4 are omitted.

In operation S510, the server 110 may obtain use history information including time information.

In an embodiment of the present disclosure, the server 110 may receive use history information of each display device from a plurality of display devices. The use history information may include time information, a viewing history of viewing channels or content, and a use history of applications or TV, but the present disclosure is not limited thereto.

In operation S515, the server 110 may obtain the use characteristics by time information and the overall use characteristics for a plurality of users.

The server 110 may obtain the use characteristics by time information by using the time information included in the use history information obtained in the operation S510. Furthermore, the server 110 may obtain the overall use characteristics for a plurality of users regardless of the time information. The use characteristics may include statistical values related to viewed channels, viewed genre, words included in content, use of applications, or use of TV, but the present disclosure is not limited thereto. In an embodiment of the present disclosure, the server 110 may obtain and store use characteristics by time information and overall use characteristics for a plurality of users.

In operation S520, the server 110 may group the use characteristics by time information into M groups by clustering the use characteristics by time information.

In an embodiment of the present disclosure, the server 110 may group a plurality of users into one or more groups by time information by clustering the use characteristics by time information. The server 110 may set or adjust the number of groups for grouping a plurality of users. Furthermore, the server 110 may group a plurality of users by using all or some of the use characteristics by time information.

In operation S525, the server 110 may group overall use characteristics by clustering the overall use characteristics into N groups.

In an embodiment of the present disclosure, the server 110 may group a plurality of users into one or more groups by clustering the overall use characteristics. The server 110 may set or adjust the number of groups for grouping a plurality of users. The server 110 may group a plurality of users by using all or some of the obtained overall use characteristics.

In operation S530, the server 110 may identify preferred channels by M groups and N groups.

In an embodiment of the present disclosure, the server 110 may identify preferred channels for each of the M groups grouped based on the use characteristics by time information. The server 110 may set or adjust the number of preferred channels to be identified. The server 110 may obtain a ranking of preferred channels of users belonging to a group by using the use characteristics, based on the number of preferred channels.

In an embodiment of the present disclosure, the server 110 may store information about the groups that are grouped through clustering and together store the preferred channels for each group.

Furthermore, the server 110 may identify preferred channels for each of the N groups groped by clustering the overall use characteristics. The server 110 may set or adjust the number of preferred channels to be identified. The server 110 may obtain a ranking of preferred channels of users belonging to a group by using the overall use characteristics, based on the number of preferred channels. In an embodiment of the present disclosure, the server 110 may store information about the groups that are grouped through clustering and together store the preferred channels for each group.

In operation S535, the server 110 may identify whether a viewing history of a user exists in a specific time slot.

When a viewing history of a user exists in a specific time slot, the server 110 may obtain a recommended channel list including preferred channels of a group that is groped based on the use characteristics by time information in the operation S540.

In an embodiment of the present disclosure, when a viewing history of a first user exists in in a specific time slot, the server 110 may identify a first group including the use characteristics by time information of the first user among the M groups for the time information including the specific time slot. The server 110 may obtain a recommended channel list including a first preferred channel corresponding to the identified first group. Furthermore, the recommended channel list may include at least one channel that the first user mainly has viewed in a specific time slot.

When no viewing history of a user exists in a specific time slot, the server 110 may obtain a recommended channel list including preferred channels of a group that is grouped based on the overall use characteristics group in the operation S545.

In an embodiment of the present disclosure, when no viewing history of the first user exists in a specific time slot, the server 110 may identify a second group including the overall use history of the first user among the N groups for the overall use characteristics. The server 110 may obtain a recommended channel list including the second preferred channel corresponding to the identified second group.

In operation S550, the server 110 may provide the recommended channel list to a first display device corresponding to the first user.

In an embodiment of the present disclosure, the server 110 may obtain a recommended channel list according to the operation S540 or S545. The server 110 may provide a recommended channel list in various forms to the first display device corresponding to the first user. For example, channel numbers corresponding to the recommended channels may be provided together with a recommended channel list, or genre to which the recommended channels belong may be provided together with a recommended channel list. Hereinafter, a specific example is described with reference to FIGS. 11A and 11B.

In an embodiment of the present disclosure, the server 110 may obtain use history information of a plurality of display devices at preset intervals and update the use history information. The server 110 may perform clustering again on a plurality of users by using the updated use history information, and recreate and provide a recommended channel list to a user

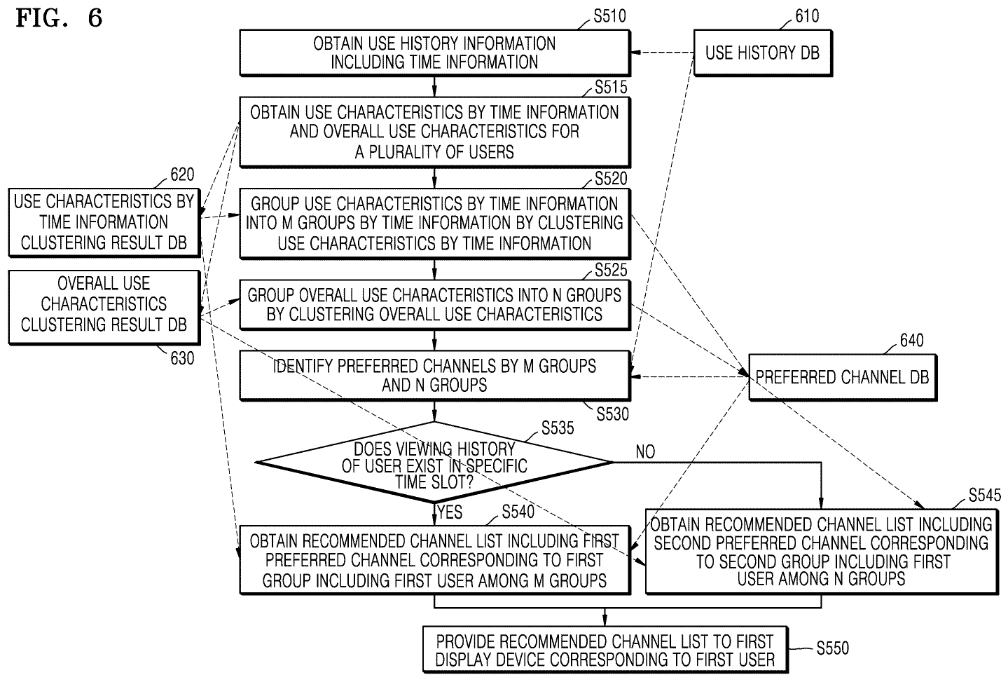

FIG. 6 is a flowchart for explaining a method of providing a user-personalized recommended channel list by using a data base, according to an embodiment of the present disclosure. Hereinafter, for a brief description of the specification, descriptions redundant to those in FIGS. 4 and 5 are omitted.

Referring to FIG. 6, a method of providing a user-personalized recommended channel list may be performed by using a data base. A data base may mean a collection of data that is organized and integrally managed for the purpose of sharing and using data among multiple entities. The server 110 may store pieces of obtained information in a data base for use, share the data base with another server, or use the data base in a calculation process.

In an embodiment of the present disclosure, the server 110 may obtain a use history of a plurality of display devices and store the obtained use history in a use history data base 610. The server 110 may use the stored use history data base 610 in an operation of identifying preferred channels for each group. In an embodiment of the present disclosure, the server 110 may use the use history data base 610 of a plurality of display devices stored by another server in the preferred channel identification operation.

The server 110 may obtain, from the use history information, the use characteristics by time information and the overall use characteristics for a plurality of users. The server 110 may group a plurality of users into M groups by time information by clustering the obtained use characteristics by time information. Furthermore, the server 110 may group a plurality of users into N groups by clustering the overall use characteristics. The server 110 may identify preferred channels for each group and obtain a ranking of preferred channels. The server 110 may store in a data base, as a result of clustering, information data base about an M group 620 and information data base about an N group 630 and preferred channel data base 640.

When a use history of a user exists in a specific time slot, the server 110 may obtain a recommended channel list by using the data base about an M group 620, in which a result of clustering the use characteristics by time information is stored, and the preferred channel data base 640. When no use history of a user exists in a specific time slot, the server 110 may obtain a recommended channel list by using the data base about an N group 630, in which a result of clustering the overall use characteristics is stored, and the preferred channel data base 640. In an embodiment of the present disclosure, the server 110 may use the data base about an M group 620 and the data base about an N group 630, in which another server stores a result of clustering a plurality of users.

FIG. 7 is a view for explaining an example of clustering a plurality of users, according to an embodiment of the present disclosure.

Referring to FIG. 7, a result 710 of grouping use characteristics into M groups by time information and a result 730 of grouping overall use characteristics into N groups are shown. The numbers M and N that are numbers of groups obtained by grouping a plurality of users may be set to be the same or different from each other.

In an embodiment of the present disclosure, the server 110 may group a plurality of users into M groups by clustering the use characteristics by time information. For example, the server 110 may group a plurality of users into M groups based on the use characteristics by time information for Monday 00:00, and may identify preferred channels for each group. The server 110 may identify that the first preferred channel of Monday 00:00 Group 1 is “MBC”, and the L-th preferred channel is “KBS”, as a result of grouping a plurality of users into M groups.

Furthermore, the server 110 may group a plurality of users into N groups by clustering the overall use characteristics. The server 110 may group a plurality of users into N groups and identify preferred channels for each group. The server 110 may identify that the first preferred channel of Group N is “SBS golf”, and the L-th preferred channel is “CNN”, as a result of grouping a plurality of users into N groups.

The server 110 may obtain a recommended channel list by using the preferred channel ranking for the use characteristics by time information or the preferred channel ranking for the overall use characteristics, depending on the presence or absence of a use history of a user in a specific time slot.

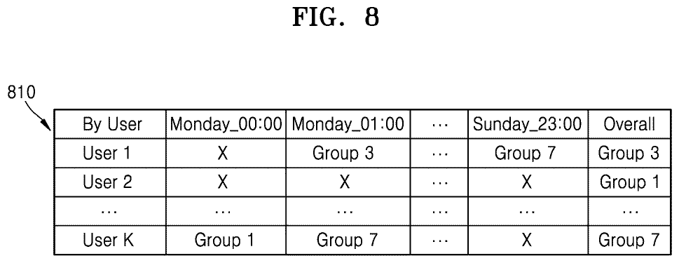

FIG. 8 is a view for explaining a clustering result for each of a plurality of users, according to an embodiment of the present disclosure.

Referring to FIG. 8, the server 110 may obtain information 810 about which group each user belongs to, based on use characteristics for each time slot or overall use characteristics, as a result of clustering the use characteristics of each of a plurality of users.

In an embodiment of the present disclosure, information about a use history of a user may not exist in a specific time slot. Accordingly, no group for the user exits in a specific time slot. For example, for User 1, as no use history exists on Monday 00:00, no group to which User 1 belongs exists. It may be checked that User 1 belongs to Group 3 on Monday 01:00, and to Group 7 on Sunday 23:00. User 1 belongs to Group 3 in a group classified by clustering the overall use characteristics.

User 2 belongs to Group 1 as a result of classifying by clustering the overall use characteristics. When use history information is insufficient as User 2, the server 110 may provide various recommended channel lists to User 2 through a result obtained by using the overall use characteristics.

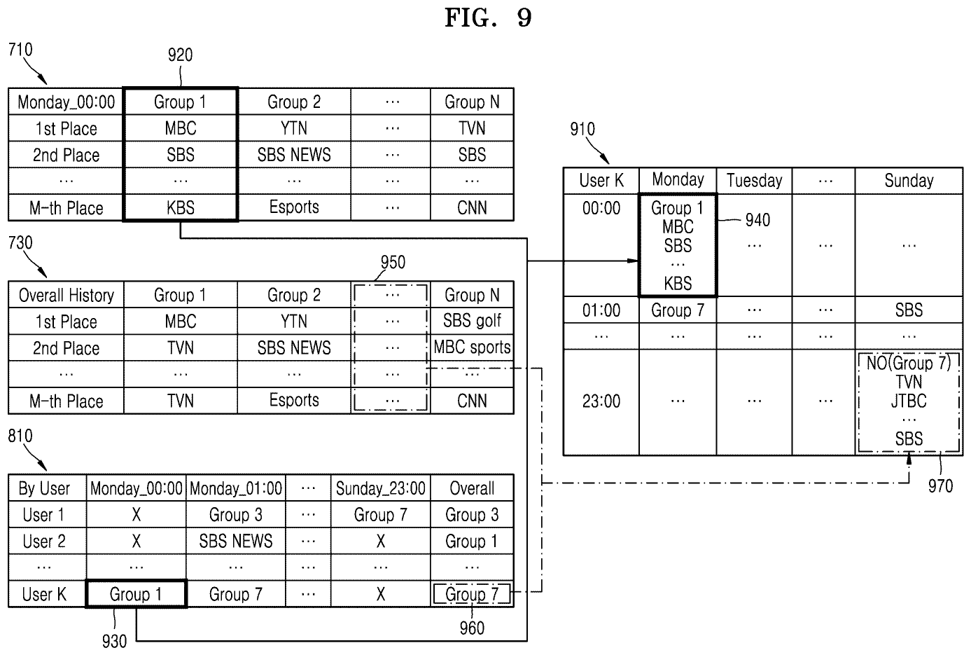

FIG. 9 is a view for explaining a method of providing a recommended channel list, according to an embodiment of the present disclosure.

Referring to FIG. 9, the server 110 may obtain a recommended channel list 910 by using information 710 and 730 about the ranking of preferred channels of a group obtained as a result of clustering the use characteristics of a plurality of users and the information 810 about a group to which a user belongs for each time slot.

In order for the server 110 to provide the recommended channel list 910 for User K, the server 110 may use the information 810 about a group to which use characteristics of User K belongs for each time slot. For example, for Monday 00:00, it may be checked that the use characteristics of User K belongs to Group 1 930. Furthermore, the server 110 may use the information 710 about the preferred channels of a group for each time slot. For example, as User K belongs to Group 1 on Monday 00:00, a recommended channel list 940 for Monday 00:00 of User K may be obtained by using a preferred channel ranking 920 of Group 1 among the information 710 about Monday 00:00. The recommended channel list may include information about the group to which the user belongs and information about the preferred channel ranking of the group. The recommended channel list may include channels viewed by User K on Monday 00:00 together with the preferred channels of Group 1.

When no use history of a user exists in a specific time slot, the server 110 may use the information 730 obtained by clustering and grouping the overall use characteristics. For example, when no use history information of User K exists on Sunday 23:00, the server 110 may check that User K belongs to Group 7 960, by using classification information obtained based on the overall use characteristics. The server 110 may use the information 730 about channels preferred by a group classified by clustering the overall use characteristics. For example, as User K belongs to Group 7, the server 110 may obtain a recommended channel list 970 for Sunday 23:00 of User K by using information 950 about a preferred channel ranking of Group 7. The recommended channel list may include which group the user belongs to and preferred channel ranking information of the group.

FIG. 10 is a view for explaining a method of clustering a plurality of users, according to an embodiment of the present disclosure.

Referring to FIG. 10, use characteristics of a plurality of users may be expressed by a point 1010, and the use characteristics may be grouped by being divided into areas 1020a, 1020b, 1020c, 1020d, 1020e, 1020f, and 1020g. The server 110 may cluster a plurality of users by various methods. Although a clustering method is described below, a method in which the server 110 clusters and classifies a plurality of users is not limited thereto.

A K-means clustering algorithm is a method of binding given data into K clusters, which is a clustering method of minimizing an average distance from each piece of data to the center of a cluster to which the data belongs. In order to minimize the average distance to the center of each cluster, K arbitrary center points are arranged, and each piece of data is assigned to the nearest center point and grouped into a group. The center point of a group is updated based on the locations of data belonging to each group, and a grouping process is repeatedly performed to minimize the average distance to the center of a cluster to which data belongs.

A K-medians clustering algorithm is a method of binding given data into K clusters, which is a modified algorithm of the K-means clustering algorithm. Not the average distance to the center of a cluster to which data belongs, but a center value is used. Like the K-means clustering algorithm, K arbitrary center points are arranged, and each piece of data is assigned to the nearest center point and grouped into a group. The center point of a group is updated based on the locations of data belonging to each group, and a grouping process is repeatedly performed to minimize the center value to the center of a cluster to which data belongs.

A mean shift algorithm performs grouping by moving the center point in a direction in which density of data is highest. A Gaussian Mixture Model (GMM) clustering algorithm performs clustering assuming that the data to which clustering is applied is a model created by mixing multiple Gaussian distribution models.

In addition, clustering methods include, as hierarchical clustering algorithms, a chameleon clustering algorithm, a clustering using representatives (CURE) algorithm, etc., but the present disclosure is not limited thereto.

FIGS. 11A and 11B are views for explaining an example of providing a user-personalized recommended channel list for each genre, according to an embodiment of the present disclosure.

Referring to FIG. 11A, a system for providing a user-personalized recommended channel list may include the server 110 and the display device 120. FIG. 11A illustrates a method according to an embodiment, in which the server 110 provides a recommended channel list together with genres 1120a and 1120b including channels, in a specific time slot 1110, through the display device 120.

In an embodiment of the present disclosure, the server 110 may obtain use characteristics by time information and overall use characteristics, based on the use history obtained from the display device 120. The server 110 may group a plurality of users by clustering the use characteristics, and provide a recommended channel list depending on the presence or absence of use history of a user in a specific time slot.

In an embodiment of the present disclosure, the use characteristics that the server 110 obtained may include information about viewed channels or genre of content. Furthermore, when the server 1100 110 groups a plurality of users by clustering use characteristics, the clustering may be performed based on information about genre. Accordingly, the server 110 may store information about the genres 1120a and 1120b about each channel or content, and provide the display device 120 with the information together when providing the recommended channel list.

In an embodiment of the present disclosure, when a use history of a user exists on Monday 17:00 1110, the server 110 may create a recommended channel list including preferred channels of a group to which the user belongs, among groups obtained by clustering the use characteristics by time information corresponding to a specific time slot. Alternatively, when no use history of a user exists on Monday 17:00 1110, the server 110 may create a recommended channel list including preferred channels of a group to which the user belongs, among groups obtained by clustering the overall use characteristics. The recommended channel list provided by the server 110 to the display device 120 may include genre.

In an embodiment of the present disclosure, when the server 110 provides a recommended channel list, the recommended channel list may be provided together with channel numbers corresponding to the channels, and channels of the same genre may be classified together and provided. For example, among the recommended channel list, recommended channels belonging to a news (1120a) genre are classified together, and recommended channels belonging to a sports (1120b) genre are classified together, and then provided to a user.

Referring to FIG. 11B, like FIG. 11A, the server 110 may provide a recommended channel list to the display device 120 by genres 1130a and 1130b. A plurality of recommended channels may be grouped together by the same genre. For example, the server 110 may provide recommended channels to the display device 120 by classifying the recommended channels belonging to the drama genre 1130a together and the recommended channels belonging to the sports genre 1130b together.

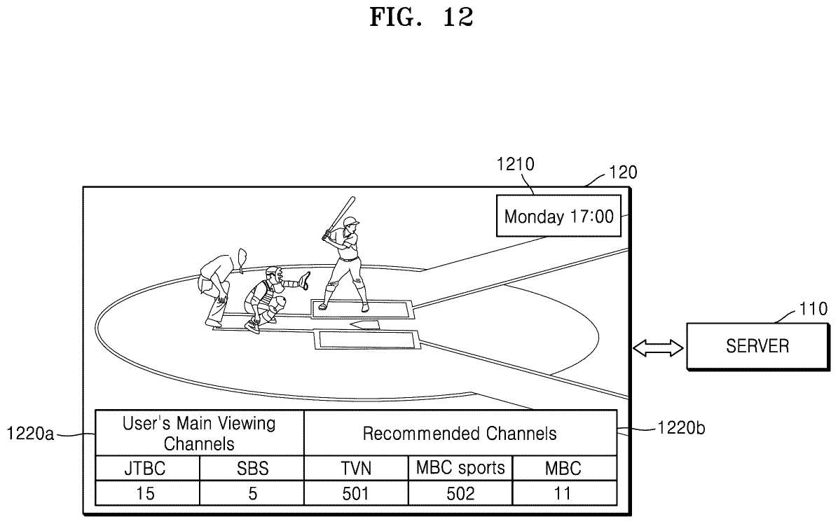

FIG. 12 is a view for explaining an example of providing a user-personalized recommended channel list, according to an embodiment of the present disclosure

Referring to FIG. 12, a user-personalized recommended channel list may include not only preferred channels of a group to which a user belongs, but also channels having a viewing history by a user in a specific time slot, as a result of clustering and grouping a plurality of users.

In an embodiment of the present disclosure, when a use history of a user exists in a specific time slot 1210, the server 110 may store a history of channels or content viewed by the user. Accordingly, when providing a recommended channel list to a user having a viewing history in the specific time slot 1210, a channel 1220a that the user viewed in a specific time slot may be provided together with a recommended channel 1220b of a group to which the user belongs.

In an embodiment of the present disclosure, a method of providing a user-personalized recommended channel list by a server may include a step of obtaining use history information including time information of a plurality of display devices. The method may include a step of obtaining, based on the use history information, use characteristics by the time information and overall use characteristics for each of the plurality of users corresponding to a plurality of display devices. The method may include a step of grouping the use characteristics by the time information for a plurality of users into M groups by clustering the same, and the overall use characteristics for a plurality of users into N groups by clustering the same. The method may include a step of obtaining a recommended channel list including at least one of a first preferred channel corresponding to a first group including use characteristics by the time information of a first user of a plurality of users among the M groups by the time information or a second preferred channel corresponding to a second group including overall use characteristics of the first user among the N groups for the overall use characteristics. The method may include a step of providing a recommended channel list to a first display device corresponding to the first user among a plurality of display devices.

In an embodiment of the present disclosure, in case that the first user has use history information corresponding to a specific time slot, the recommended channel list may include the first preferred channel corresponding to the first group including the first user among the M groups for the time information including the specific time slot.

In an embodiment of the present disclosure, in case that the first user has no use history information corresponding to a specific time slot, the recommended channel list may include the second preferred channel corresponding to the second group including the first user among N groups for the overall use characteristics.

In an embodiment of the present disclosure, the use history information may include at least one of channel viewing history information by the time information, content viewing history information by the time information, application use history information by the time information, or TV use history information by the time information of a plurality of users.

In an embodiment of the present disclosure, the use characteristics by the time information and the overall use characteristics may include a statistical value for viewing history or a statistical value for use history.

In an embodiment of the present disclosure, the method may include a step of configuring the number of preferred channels included in the recommended channel list. The method may include a step of identifying preferred channels for the M groups by time information and the N groups for the overall use characteristics based on the number of preferred channels and obtaining a recommended channel list based on the identified preferred channels.

In an embodiment of the present disclosure, the method may include a step of storing the M groups by the time information and the N groups for the overall use characteristics may be stored, and storing preferred channels for the groups.

In an embodiment of the present disclosure, the preferred channels for the groups may include channels related to a channels genres, or contents viewed by the plurality of users included in the M groups and the N groups.

In an embodiment of the present disclosure, the method may include a step of obtaining updated use history information at preset intervals, and obtaining a recommended channel list based on the updated use history information.

In an embodiment of the present disclosure, in case that the first user has use history information corresponding to a specific time slot, the recommended channel list may include channels viewed by the first user based on the use history information.

In an embodiment of the present disclosure, a server for providing a user-personalized recommended channel list may include a transceiver, a memory storing one or more instructions, and at least one processor that executes the one or more instructions. The at least one processor may obtain use history information including time information of a plurality of display devices, and use characteristics by time information and overall use characteristics for each of a plurality of users corresponding to a plurality of display devices based on the use history information. A server according to an embodiment may group the use characteristics by the time information for a plurality of users into M groups by time information by clustering the use characteristics by the time information for the plurality of users, and group the overall use characteristics for a plurality of users into N groups by clustering the overall use characteristics for the plurality of users. A server according to an embodiment may obtain a recommended channel list including at least one of a first preferred channel corresponding to a first group including use characteristics by the time information of a first user of a plurality of users among the M groups by the time information or a second preferred channel corresponding to a second group including overall use characteristics of the first user among the N groups for the overall use characteristics. A server according to an embodiment may provide a recommended channel list to a first display device corresponding to a first user among a plurality of display devices.

A computer-readable storage medium may be provided in the form of a non-transitory storage medium. The ‘non-transitory may’ mean that a storage medium is a tangible device, not including a signal (e.g., an electromagnetic wave). However, the term does not distinguish a case of semi-permanently storing data in a storage medium from a case of temporarily storing data. For example, a ‘non-transitory storage medium’ may include a buffer in which data is temporarily stored.

According to an embodiment, a method according to various embodiments disclosed in the present specification may be provided by being included in a computer program product. A computer program product as goods may be dealt between a seller and a buyer. The computer program product is distributed in the form of a machine-readable storage medium, for example, a compact disc read only memory (CD-ROM), or through application stores, for example, Play Store™, or can be distributed directly or online, for example, download or upload, between two user devices, for example, smart phones. In the case of online distribution, at least a part of the computer program product may be at least temporarily stored or temporarily generated in a machine-readable storage medium such as a manufacturer's server, an application store's server, or a memory of a relay server.

1. A method of providing a user-personalized recommended channel list by a server, the method comprising:
obtaining use history information including time information of a plurality of display devices;
obtaining, based on the use history information, use characteristics by the time information and overall use characteristics for each of a plurality of users corresponding to the plurality of display devices;
grouping the use characteristics by the time information for the plurality of users into M groups by the time information by clustering the use characteristics by the time information for the plurality of users;
grouping the overall use characteristics for the plurality of users into N groups by clustering the overall use characteristics for the plurality of users;
obtaining a recommended channel list including at least one of a first preferred channel corresponding to a first group including use characteristics by the time information of a first user of the plurality of users among the M groups by the time information or a second preferred channel corresponding to a second group including overall use characteristics of the first user among the N groups for the overall use characteristics; and
providing the recommended channel list to a first display device corresponding to the first user among the plurality of display devices.

2. The method of claim 1, wherein, in case that the first user has use history information corresponding to a specific time slot, the recommended channel list includes the first preferred channel corresponding to the first group including the first user among the M groups for the time information including the specific time slot.

3. The method of claim 1, wherein, in case that the first user has no use history information corresponding to a specific time slot, the recommended channel list includes the second preferred channel corresponding to the second group including the first user among the N groups for the overall use characteristics.

4. The method of claim 1, wherein the use history information includes at least one of channel viewing history information by the time information, content viewing history information by the time information, application use history information by the time information, or TV use history information by the time information of the plurality of users.

5. The method of a claim 1, wherein the use characteristics by the time information and the overall use characteristics include a statistical value for viewing history or a statistical value for use history.

6. The method of claim 1, further comprising:
storing the M groups by the time information and the N groups for the overall use characteristics; and
storing the preferred channels for the M groups and the N groups.

7. The method of claim 1, wherein the preferred channels for groups include channels related to channels genres, or contents viewed by the plurality of users included in the M groups and the N groups.

8. The method of claim 1, further comprising:
obtaining updated use history information based on preset intervals; and
obtaining the recommended channel list based on the updated use history information.

9. A server for providing a user-personalized recommended channel list, the server comprising:
a transceiver;
a memory storing one or more instructions; and
at least one processor configured to execute the one or more instructions to:
obtain use history information including time information of a plurality of display devices,
obtain, based on the use history information, use characteristics by the time information and overall use characteristics for each of a plurality of users corresponding to the plurality of display devices,
group the use characteristics by the time information for the plurality of users into M groups by the time information by clustering the use characteristics by the time information for the plurality of users,
group the overall use characteristics for the plurality of users into N groups by clustering the overall use characteristics for the plurality of users,
obtain a recommended channel list including at least one of a first preferred channel corresponding to a first group including use characteristics by the time information of a first user of the plurality of users among the M groups by the time information or a second preferred channel corresponding to a second group including overall use characteristics of the first user among the N groups for the overall use characteristics, and
provide the recommended channel list to a first display device corresponding to the first user among the plurality of display devices.

10. The server of claim 9, wherein, in case that the first user has use history information corresponding to a specific time slot, the recommended channel list includes the first preferred channel corresponding to the first group including the first user among the M groups for the time information including the specific time slot.

11. The server of claim 9, wherein, in case that the first user has no use history information corresponding to a specific time slot, the recommended channel list includes the second preferred channel corresponding to the second group including the first user among the N groups for the overall use characteristics.

12. The server of claim 9, wherein the use history information includes at least one of channel viewing history information by the time information, content viewing history information by the time information, application use history information by the time information, or TV use history information by the time information of the plurality of users.

13. The server of claim 9, wherein the use characteristics by the time information and the overall use characteristics include a statistical value for viewing history or a statistical value for use history.

14. The server of claim 9, wherein the at least one processor is further configured to execute the one or more instructions to:
obtain updated use history information based on preset intervals; and
obtain the recommended channel list based on the updated use history information.

15. A non-transitory computer-readable recording medium having recorded thereon a program to perform, on a computer, the method according to claim 8.
